(19) United States
(12) Patent Application Publication
(10) Pub. No.: US 2026/0196782 A1
(43) Pub. Date: Jul. 9, 2026

(54) CONNECTOR WITH AN IMPROVED LIMITING STRUCTURE

(71) Applicant: FOXCONN INTERCONNECT TECHNOLOGY LIMITED, Grand Cayman (KY)

(72) Inventor: YUNG-CHIH HUNG, New Taipei (TW)

(21) Appl. No.: 19/438,969

(22) Filed: Jan. 2, 2026

(30) Foreign Application Priority Data
Jan. 8, 2025 (CN) 202520042570.0

(51) Int. Cl. H01R 13/74

(52) U.S. Cl. CPC H01R 13/743

(57) ABSTRACT

A connector adapted for being mounted on a panel includes: a body including a flat portion with a front face, and a mating portion extending forward from the front face and having a mating slot opening forwards in a mating direction; two power terminals having contacting portions exposed to the mating slot in a first direction; a conductive member including a sheet portion retained on the front face, and plural elastic arms attached to an outside of the mating portion and protruding away from the mating slot in the first direction; and a limiting portion extending from the sheet portion; wherein the flat portion has a slot recessed from the front face, the limiting portion protrudes forwards in the mating direction to limit the connector on the panel, and a distal end of the limiting portion retracts in the slot during assembling the connector to the panel.

### BACKGROUND OF THE INVENTION

### 1. Field of the Invention

The present invention relates to a connector with an improved limiting structure.

### 2. Description of Related Arts

U.S. Pat. No. 12,413,028 discloses an electrical connector for mounting to a panel. The connector includes a connector housing having a base, a flange, and a plug. The connector housing has a contact channel holding a contact. The electrical connector includes a latch member integral with the connector housing and located within the flange. The latch member includes a deflectable latch arm and a latching finger extending from the latch arm. The plug is configured to be inserted into a panel opening of the panel in a loading direction. The connector housing is movable laterally relative to the panel in a latching direction to a latched position. The plug is movable in the panel opening in the latching direction. The latching finger engages an inner edge of the panel opening when the housing is in the latched position to hold the connector housing in the latched position.

### SUMMARY OF THE INVENTION

An object of the present invention is to provide a connector with an improved limiting structure.

To achieve the above-mentioned object, a connector adapted for being mounted on a panel of a device comprises: a body comprising a flat portion with a front face, and a mating portion extending forward from the front face of the flat portion and having a mating slot opening forwards in a mating direction; two power terminals disposed on the body and having contacting portions exposed to the mating slot in a first direction; a conductive member comprising a sheet portion retained on the front face of the flat portion, and plural elastic arms attached to an outside of the mating portion and protruding away from the mating slot in the first direction; and a limiting portion extending from the sheet portion; wherein the flat portion has a slot recessed from the front face of the flat portion, the limiting portion protrudes forwards in the mating direction to limit the connector on the panel, and a distal end of the limiting portion retracts in the slot during assembling the connector to the panel.

Other advantages and novel features of the invention will become more apparent from the following detailed description of the present embodiment when taken in conjunction with the accompanying drawings.

### BRIEF DESCRIPTION OF DRAWINGS

FIG. 1 is a front and top perspective view of a connector according to an embodiment of the present application, wherein the limiting structure is in a natural state;

FIG. 2 is a perspective view of the connector in FIG. 1, wherein the limiting structure is in a compressed state;

FIG. 3 is an exploded perspective view of the connector in FIG. 1;

FIG. 4 is a perspective view of the connector during an assembling process to a panel, wherein the limiting structure is in the compressed state;

FIG. 5 is a perspective view of the connector after being assembled on the panel wherein the limiting structure recovers to the natural state;

FIG. 6 is a cross-sectional view of the connector taken a line A-A in FIG. 5; and

FIG. 7 is an exploded perspective view of the connector and the panel in FIG. 5.

### DETAILED DESCRIPTION OF THE PREFERRED EMBODIMENT

Reference will now be made to the drawing figures to describe the preferred embodiment of the present invention in detail.

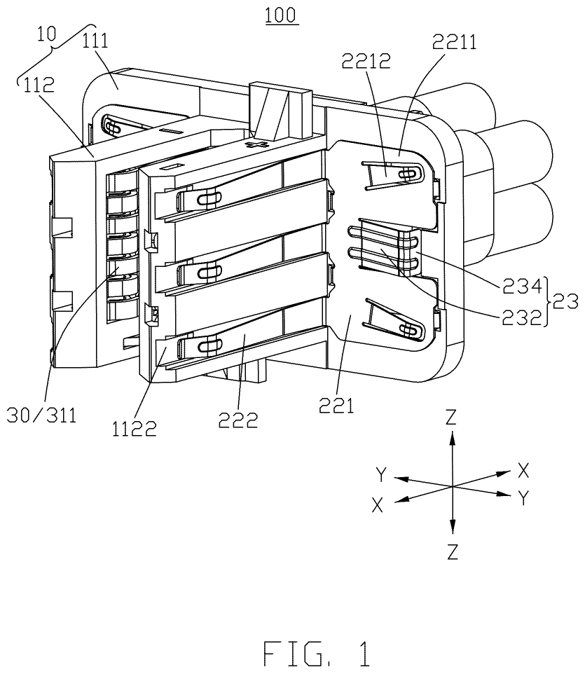

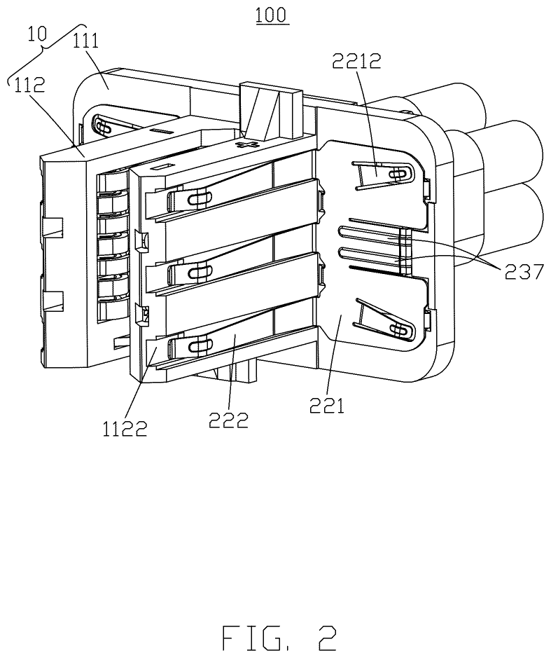

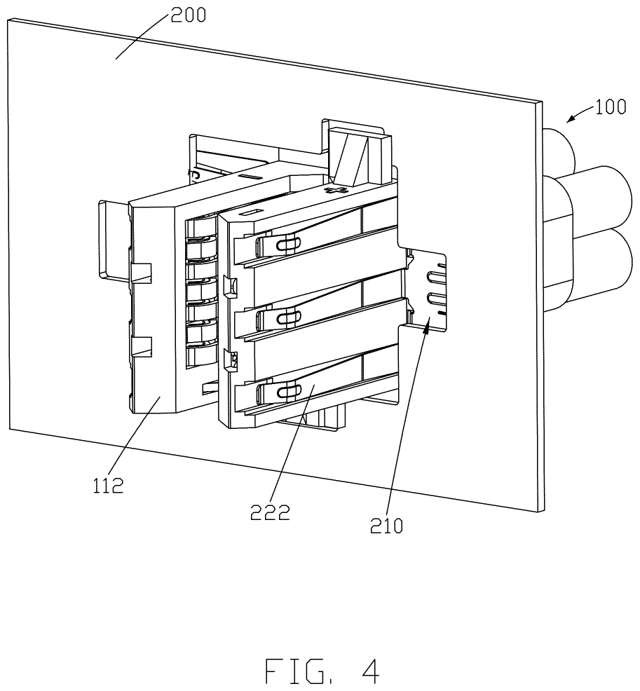

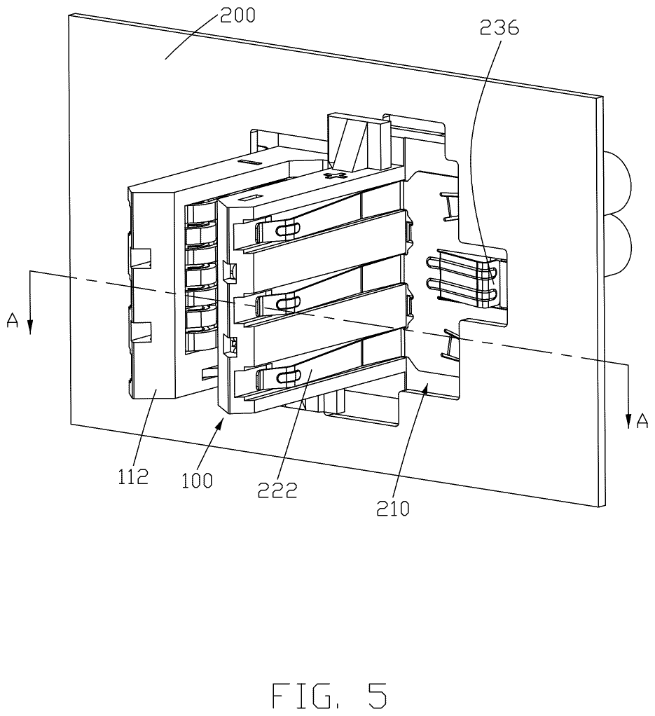

Referring to FIGS. 1 to 2, a connector 100 of an embodiment is illustrated, and the connector 100 is used to connect with an electrical component of an device to achieve an electrical connection. In some embodiments, the connector 100 may be an electrical connector transmitting power current and is retained on a panel 200 of the electric device as shown in FIGS. 4-5. The connector 100 may include a body 10 and a limiting structure 20. The limiting structure 20 is disposed on the body 10 and is used for assembling and positioning the connector 100 on the panel 200 of the electronic device.

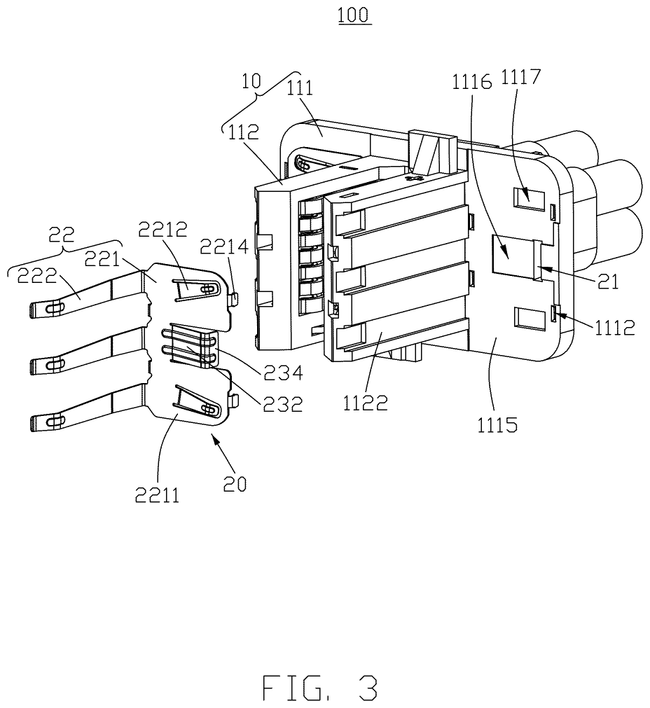

Referring to FIGS. 1-3, the body 10 may be made from insulating material, and may include a flat portion 111 and a mating portion 112. The mating portion 112 protrudes forward from the flat portion 111 in a mating direction X-X of the connector and is used to mate with another electronic component, such as power bus bar used in a rack, the flat portion 111 is used to be attached to the panel 200 to retain the connector 100 on the panel. The mating portion 112 has a mating slot 113, two power terminals 30 are disposed on opposite sides of the mating slot 113 and include contacting portions 311 extending in the mating slot 113 in a first direction Y-Y.

The limiting structure 20 may include a slot 21 and a conductive member 22 and a limiting portion 23. In some embodiments, the slot 21 is disposed on the body. The mating portion 112 extends from a front face 1115 of the flat portion 111, the slot 21 is recessed from the front face 1115 of the flat portion 111, and is located at a side of the mating portion 112 in the first direction Y-Y.

The conductive member 22 is disposed on the body 10. The conductive member 22 are disposed at an outside of the mating portion 112 and the front face 1115 of the flat portion 111 to electrically connect with electronic components of the electronic device for establishing a grounding patch, that is, the conductive member is a grounding member.

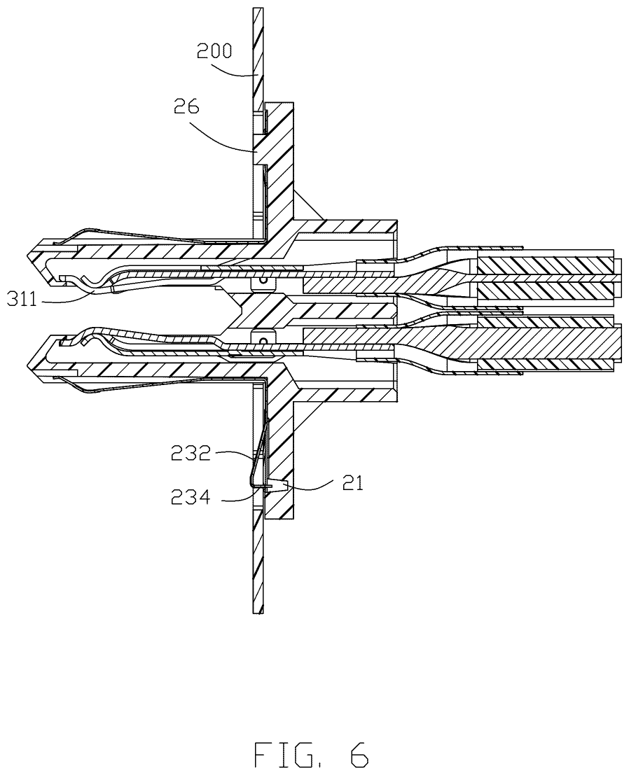

The limiting portion 23 connects with the conductive member 22. The limiting portion 23 is deformable and can partly move into the slot 21. In some embodiments, the limiting portion 23 is generally in the form of a bent sheet and may include a first arm 232 and a second arm 234 connected with each other at a preset angle. The first arm 232 is connected to the conductive member 22, and the second arm 234 can move into the slot 21. The flat portion 111 has a shallow depression 1116 recessed rearward from the front face 1115 thereof and aligned with the limiting portion 23 in the mating direction X-X. The second arm 234 is disposed perpendicular to the front face 1115 of the flat portion 111 as best shown in FIG. 6. The limiting portion 23 has two ribs 237 extending from the first arm 232 to the second arms 234 to enlarger than strength of the limiting portion.

In some embodiments, the limiting portion 23 is elastic. In a natural state of the limiting portion 23 as shown in FIG. 1, the limiting portion 23 protrudes forwards beyond the front face 1115 in the mating direction X-X, so as to provide a stop face 236. As clearly show in FIG. 6, a distal end of the second arm 234 is received in the slot 21 in the natural state for guiding. The first arm and the second arm bend in a V shape protruding forwards. When the limiting portion 23 is subjected to an external force, the limiting portion 23 is elastically compressed, causing the second arm 234 to be fully accommodated within the slot 21, and the first arm 232 to be parallel with the front face 1115 of the flat portion 111 as shown in FIG. 2. At this point, the limiting portion 23 does not protrude beyond the front face 1115 of the platform portion 111. When the external force on the limiting portion 23 is removed, the limiting portion 23 elastically restores and protrudes forwards beyond the front face 1115. In other words, the limiting portion 23 restores to the natural state. As clearly shown in FIG. 1, the limiting portion 23 is in the natural state, wherein the limiting portion 23 protrudes beyond the font face 1115 of the flat portion 111. As clearly shown in FIG. 2, the limiting portion 23 is in the compressed state, wherein the second arm 234 of the limiting portion 23 is be fully accommodated within the slot 21, and the first arm 232 is flush with the front face 1115 of the flat portion 111.

In some embodiments, the limiting portion 23 can be integrally formed with the conductive member 22. Both the limiting portion 23 and the conductive member 22 are made of conductive materials. In some embodiments, the limiting portion 23 and the conductive member 22 can be an integrally formed metal sheet, capable of conducting current together.

The conductive member 22 may include a sheet portion 221 and plural conductive arms 222 bending from the sheet portion 221. The sheet portion 221 is retained on the front face 1115 of the flat portion, and the elastic arms 222 are attached to the outside of the mating portion 112 and protruding away from the mating slot 113 in the first direction Y-Y. The limiting portion 23 extends from the sheet portion 221 and protrudes forwards in the mating direction X-X to limit the connector on the panel 200. The first arm 232 slants forwards from the sheet portion 221, and the second arm 234 bends rearwards from the first arm 232. The ribs 237 extend beyond a joint of the first arm with the sheet portion.

The sheet portion 221 comprises two wing portions 2211 at opposite sides of the limiting portion 23 in a second direction Z-Z perpendicular to the mating direction X-X and the first direction Y-Y, each of the wing portion 2211 has an elastic finger 2212 slanting forward and outwards. The two wing portions 221 are spaced apart and arranged in a coplanar manner on the front face 1115 of the flat portion 111. The sheet portion 221 is connected in a generally U-shaped sheet structure. The elastic arm 2212 protrudes from the front face 1115 of the flat portion 111, and the protrusion direction of the elastic arm 2212 is the same as that of the limiting portion 23. In some embodiments, the elastic arm 2212 can be used to buffer the impact force when the connector 100 is connected to electrical components of the electronic device. The flat portion 111 has a shallow depression 1117 recessed from the front face 1115 thereof and aligned with the elastic fingers 2212.

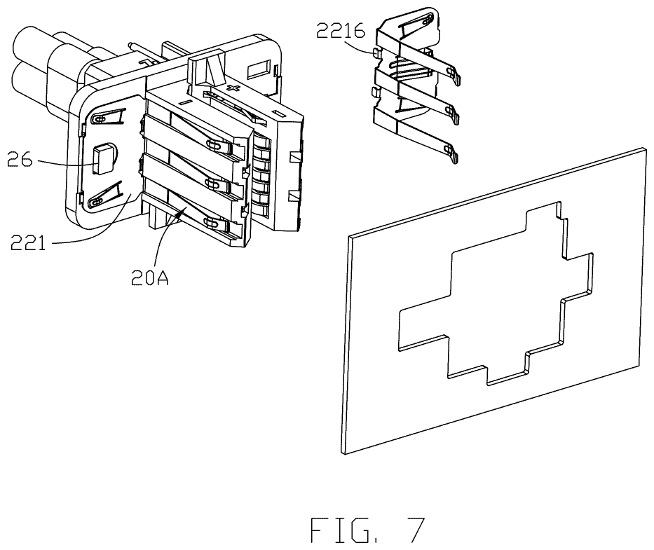

In some embodiments, the sheet portion 221 further includes two first retaining tabs 2214 at outer edges of the wing portions 2211. The flat portion 111 has two first holes 1112. The retaining tabs 2214 are respectively inserted and retained in the holes 1112, allowing the sheet portion 221 to be securely fixed to the flat portion 111. Further, as shown in FIG. 7, the sheet portion 221 has two second retaining tabs 2216 at an inner edge thereof to be inserted and retained in holes on the flat portion 111.

In some embodiments, several elastic arms 222 are spaced apart and arranged in a coplanar manner, and are disposed on the outside of the mating portion 112. The elastic arms 222 are spaced and connected to sheet portion 221 at a preset angle. In some embodiments, the conductive member 22 may include three elastic arms 222. The mating portion 112 has three passages 1122. The three elastic arms 222 are respectively accommodated within the three passages 1122, allowing the three elastic arms 222 to be securely fixed to the mating portion 112. That is, the conductive sheet includes the sheet portion 221, the elastic arms 222 and the limiting portion 23.

During the assembly of the connector 100, the conductive member 22 and the limiting portion 23 are integrally formed. The first and the second retaining tabs 2214, 2216 are correspondingly assembled into the holes 1112, and the sheet portion 221 is arranged along the front face 1115 of the flat portion 111. The elastic arms 222 are correspondingly accommodated within the passages 1122 of the mating portion 112, so that the elastic arms 222 are arranged along the mating portion 112. The limiting portion 23 protrudes from the front face of the flat portion 111.

When the connector 100 is assembled to the panel 200, the panel 200 has an assembly hole 210. The mating portion 112 goes forwards across the assembly hole 210, and the elastic fingers 2212 and the sheet portion 221 presses forwards against the panel 200. At this point, the limiting portion 23 is elastically compressed until the second arm 234 is fully accommodated within the slot 21, and the first arm 232 becomes flush with the front face 1115 of the flat portion 111, that is, the limiting portion 23 is in the compressed state. Next, the connector 100 moves relative to the surface of the panel 200 until the limiting portion 23 shifts to the assembly hole 210 and releases from the panel 200. The limiting portion 23 recovers, protruding forwards across the assembly hole 210. As a result, the stop face 236 of the limiting portion 23 limit the panel 200, restricting the relative movement between the connector 100 and the panel 200. Therefore, the limiting portion extending from the conductive member facilitates the assembly and positioning of the connector 100 with the panel of the electronic device.

In this embodiment, the connector 100 includes two conductive sheets, one of the conductive sheet includes the conductive member 22 and the limiting portion 23, another conductive sheet 20A is located at another outside of the mating portion 112 as shown in FIG. 7. The conductive sheet 20B has no limiting portion split from the sheet portion 221 of the conductive sheet 20B, a preliminary limiting position 26 unitarily extends from the front face 1115 of the flat portion 111. Alternatively, the preliminary limiting position 26 can be split from the sheet portion 221.

The above-mentioned embodiments are only preferred embodiments of the present invention, and should not limit the scope of the present invention, any simple equivalent changes and modifications made according to the claims of the present invention and the contents of the description should still belong to the present invention.

1. A connector adapted for being mounted on a panel of a device, the connector comprising:
a body comprising a flat portion with a front face, and a mating portion extending forward from the front face of the flat portion and having a mating slot opening forwards in a mating direction;
two power terminals disposed on the body and having contacting portions exposed to the mating slot in a first direction;
a conductive member comprising a sheet portion retained on the front face of the flat portion, and plural elastic arms attached to an outside of the mating portion and protruding away from the mating slot in the first direction; and
a limiting portion extending from the sheet portion;
wherein the flat portion has a slot recessed from the front face of the flat portion, the limiting portion protrudes forwards in the mating direction to limit the connector on the panel, and a distal end of the limiting portion retracts in the slot during assembling the connector to the panel.

2. The connector as claimed in claim 1, wherein:
the limiting portion comprises a first arm slanting forwards from the sheet portion and a second arm bending rearwards from the first arm, and a distal end of the second arm is received in the slot;
the second arm is pushed to wholly retract into the slot and the first arm is pushed to be parallel to the front face of the flat portion during assembling the connector to the panel; and
the first arm and the second arm restore after the connector is assembled to the panel.

3. The connector as claimed in claim 2, wherein the sheet portion comprises two wing portions at opposite sides of the limiting portion in a second direction perpendicular to the mating direction and the first direction, and each of the wing portion has an elastic finger slanting forward and outwards.

4. The connector as claimed in claim 3, wherein the flat portion has a shallow depression recessed from the front face thereof and aligned with the elastic fingers.

5. The connector as claimed in claim 3, wherein each of the wing portions has a first retaining tab, and the first retaining tab is inserted and retained in a first hole defined on the front face of the flat portion.

6. The connector as claimed in claim 5, wherein the sheet portion has a second retaining tab extending the sheet portion and located between every two adjacent elastic arms, and the second retaining tab is retained in a hole defined on the front face of the flat portion.

7. The connector as claimed in claim 1, wherein the flat portion has a shallow depression recessed from the front face thereof and aligned with the limiting portion in the mating direction.

8. The connector as claimed in claim 1, wherein the mating portion has plural passages recessed from the outside thereof in the first direction and each running forwards, and the elastic arms are received in the passages respectively and retract within the passages when the elastic arms are pushed.

9. A connector comprising:
an insulating body comprising a flat portion with a front face and a mating portion extending forward from the front face of the flat portion in a mating direction, the mating portion having a mating slot opening forwards and opposite outsides facing away from the mating slot;
two power terminals disposed in the insulating body and having contacting portions protruding to the mating slot in a first direction; and
two conductive sheets, each comprising a sheet portion retained on the front face of the flat portion, and plural elastic arms attached to a corresponding outside of the mating portion and protruding away from the mating slot in the first direction;
wherein one of the two conductive sheets has a limiting portion, the limiting portion splits from the sheet portion and bends in a V-shape protruding forwards to have a stopping face facing away from the mating slot.

10. The connector as claimed in claim 9, wherein the limiting portion comprises a first arm extending from the sheet portion and a second arm bending rearwards from the first arm.

11. The connector as claimed in claim 10, wherein the flat portion has a slot recessed from the front face thereof, and the second arm retract into the slot when the first arm is pushed rearwards.

12. The connector as claimed in claim 11, wherein the second arm is disposed perpendicular to the front face of the flat portion.

13. The connector as claimed in claim 10, wherein the limiting portion has two ribs extending from the first arm to the second arm.

14. The connector as claimed in claim 10, wherein the ribs extend beyond a joint of the first arm with the sheet portion.

15. The connector as claimed in claim 9, wherein the flat portion has a shallow depression recessed from the front face thereof and aligned with the limiting portion in the mating direction.

16. The connector as claimed in claim 9, wherein the sheet portion has two elastic fingers split therefrom and located at opposite sides of the limiting portion in a second direction perpendicular to the mating direction and the first direction, and the elastic finger slants forwards and away from the mating direction.
